(19) United States
(12) Patent Application Publication
(10) Pub. No.: US 2011/0090713 A1
(43) Pub. Date: Apr. 21, 2011

(54) FLEXIBLE BACKLIGHT MODULE

(75) Inventors: Ming-Hung Chen, Hsinchu County (TW); Jing-Yi Chen, Hsinchu County (TW)

(73) Assignee: Helio Optoelectronics Corporation, Zhudong Town, Hsinchu County (TW)

(21) Appl. No.: 12/990,068

(22) PCT Filed: Jul. 8, 2008
(86) PCT No.: PCT/CN2008/001290

§ 371 Date: Oct. 28, 2010

(51) Int. Cl. F21V 8/00; F21V 7/04

(52) U.S. Cl. 362/612; 362/614; 362/615; 362/628; 362/629; 362/623; 362/619

(57) ABSTRACT

A flexible backlight module includes a light source module and a flexible light guide panel, wherein the flexible light guide panel has a light incident surface, a light reflecting surface, and a light outgoing surface. The light incident surface of the flexible light guide panel is directly connected and thereby optically coupled to the light source module so that the light emitted by the light source module can be completely coupled to the flexible light guide panel. Consequently, the loss of light is reduced while the luminous efficiency of light is increased. Light entering the flexible light guide panel is reflected by the light reflecting surface to the light outgoing surface and then projected outward. The flexible light guide panel can be curved as needed thanks to its flexibility and thus features a wide application range.

### BACKGROUND OF THE INVENTION

1. Technical Field

The present invention relates to a flexible backlight module, and more particularly, to a flexible backlight module applicable to backlight modules.

2. Description of Related Art

Nowadays, Liquid crystal displays (LCD) are widely used display devices on the market, with applications ranging from mobile phones to laptop computers, digital cameras, and so on. Generally speaking, the two major components of an LCD are the Liquid crystal panel and the backlight module. The Liquid crystal panel is responsible for the presentation of colors but is incapable of emitting light by itself. Therefore, the backlight module is required at the back of the Liquid crystal panel to provide sufficient light and thereby enable the LCD to display images.

Large LCDs that are currently under active development are mainly used in outdoor advertisement, such as the ones mounted on the exterior walls of buildings. If the walls are of irregular shapes, it is required that a plurality of small displays be manufactured and then joined together to form a large display for outdoor advertisement. However, the process of manufacturing multiple small displays and then joining them together increases both production cost and production time. As for small LCDs, their application range has been restricted by the standard shapes.

Taiwan Patent No. 1270724, entitled flexible backlight module and System of Manufacturing the Same, discloses a flexible backlight module comprising: a lower flexible panel having a plurality of grooves; at least a light guide device, each disposed in a corresponding one of the grooves and configured to guide light through the opening of the corresponding groove; and an upper flexible panel laid over the lower flexible panel and configured to receive the light emitted from each groove and then emit the received light.

In the afore-cited prior art, the flexibility of the flexible panels allows the backlight module to be curved and comply with objects of irregular shapes, thus reducing the steps of manufacturing large displays. However, as the light emitted from the light source is coupled to the backlight module through the a light guide material, the light provided by the light source is likely to leak during the light coupling process, thereby compromising the efficiency of the backlight module as a whole.

It can be known from the above that existing backlight modules, like the one described above, still leave much room for improvement in terms of structure and use. While related manufacturers have made great effort to find a solution, a suitable design has yet to be developed, and commercially available products continue to be inadequate in solving the foregoing problem. Therefore, the development of a novel flexible backlight module has now become an important subject in the industry.

In view of the aforesaid drawbacks of existing backlight modules, the present inventor began active research and innovation based on pertinent theories and professional knowledge as well as years of practical experience in the design and manufacture of related products, with the object of creating a new flexible backlight module that is capable of improving the conventional backlight modules and adding practical value thereto. After repeated trials and improvement, a flexible backlight module of high practical value is finally created as disclosed herein.

### BRIEF SUMMARY OF THE INVENTION

It is an object of the present invention to overcome the shortcomings of existing backlight modules by providing a novel flexible backlight module. The technical problem to be solved is to make a flexible backlight module composed of a light source module and a flexible light guide panel, wherein the flexible light guide panel, due to its flexibility, can be curved and is therefore suitable for use in conjunction with all kinds of products.

Another object of the present invention is to provide the foregoing flexible backlight module, wherein the technical problem to be solved is to connect the light incident surface of the flexible light guide panel integrally with the light source module so as to provide optical coupling therebetween. Thus, not only the assembly procedure but also the components of the flexible backlight module can be simplified, making the flexible backlight module more practical than the conventional ones.

Another object of the present invention is to provide the foregoing flexible backlight module, wherein the technical problem to be solved is to couple the light of the light source module completely to the inside of the flexible light guide panel so as to prevent loss of light and increase the light emission efficiency of the flexible backlight module, thereby making the flexible backlight module even more practical than the conventional ones.

The objects of the present invention and the measures to solve the aforesaid technical problems can be realized by the following technical means. According to the present invention, a flexible backlight module is characterized by comprising: a light source module; and a flexible light guide panel having a light incident surface, a light reflecting surface, and a light outgoing surface, wherein the light incident surface is directly connected and thereby optically coupled to the light source module.

The objects of the present invention and the measures to solve the abovementioned technical problems can be further realized by the following technical means.

In the foregoing flexible backlight module, the light source module is a cold cathode fluorescent lump light source module or a light-emitting diode (LED) light source module.

In the foregoing flexible backlight module, the flexible light guide panel is in the form of a slab or a strip.

In the foregoing flexible backlight module, the flexible light guide panel is Made of a flexible material, a silicone, an epoxy resin, or a mixture of a silicone and an epoxy resin.

In the foregoing flexible backlight module, the light reflective surface has a plurality of reflective structures.

In the foregoing flexible backlight module, a plurality of reflective projections or a metallic reflector is formed on the light reflective surface.

In the foregoing flexible backlight module, a plurality of microlenses is formed on the light outgoing surface.

In the foregoing flexible backlight module, there is a plurality of microstructures on the light outgoing surface.

In the foregoing flexible backlight module, the light reflecting surface has a plurality of reflective structures while the light outgoing surface has a plurality of microstructures.

The present invention is apparently more advantageous and more beneficial than the prior art. In order to achieve the abovementioned objects, the present invention provides a flexible backlight module which comprises: a light source module; and a flexible light guide panel having a light incident surface, a light reflecting surface, and a light outgoing surface, wherein the light incident surface is closely connected to the light source module. By adopting the technical solution stated above, the flexible backlight module of the present invention at least provides the following advantages and beneficial effects:

1. As the light source module is directly connected and thereby optically coupled to the light guide panel, the loss of light is reduced while the lighting intensity of the backlight module is increased.

2. As the assembly procedure and the components are simplified, the production cost of the backlight module is reduced.

3. The flexible backlight module can be curved according to practical needs and therefore features wide applicability.

To sum up, the present invention is composed of a light source module and a flexible light guide panel, wherein the flexible light guide panel has a flexible property that allows the flexible light guide panel to be curved and therefore suitable for use in conjunction with various products. Besides, as the light incident surface of the flexible light guide panel is integrally connected to the light source module to enable optical coupling therebetween, the assembly procedure and the components of the flexible backlight module are both simplified, and the light provided by the light source module can be completely coupled to the flexible light guide panel. Consequently, the loss of light is reduced while the light emission efficiency of the flexible backlight module is increased. The aforesaid advantages add to the practical value of the present invention. The present invention provides substantial improvement in structure or function, involves significant technical progress, and is easy to use and practical. Compared with existing backlight modules, the present invention has several additional outstanding features and wider applicability. In a nutshell, the present invention is indeed a novel, inventive, and useful design.

The above description is only a summary of the technical solution of the present invention. In order to shed more light on the technical means of the present invention, a detailed description of the preferred embodiments is provided below with reference to the accompanying drawings so that a person skilled in the art can easily understand the above and other objects, as well as the characteristics and advantages, of the present invention and implement the present invention according to the contents disclosed herein.

### BRIEF DESCRIPTION OF THE SEVERAL VIEWS OF THE DRAWINGS

FIG. 1 is a perspective view of a flexible backlight module according to the first preferred embodiment of the present invention;

FIG. 2 is a perspective view of a flexible backlight module according to the second preferred embodiment of the present invention;

FIG. 3 is a sectional view taken along section line A-A in FIG. 2;

FIG. 4 is a sectional view of a flexible backlight module according to the third preferred embodiment of the present invention; and

FIG. 5 is a sectional view of a flexible backlight module according to the fourth preferred embodiment of the present invention.

### DETAILED DESCRIPTION OF THE INVENTION

To further demonstrate the technical means adopted by the present invention to achieve the intended objects and the effects of such technical means, a detailed description of the best mode of carrying out the invention, as well as the structure, characteristics, and functions of the disclosed flexible backlight module, is given below with reference to the accompanying drawings and the preferred embodiments.

The above and other technical contents, features, and effects of the present invention are clearly presented in the detailed description of the preferred embodiments and the accompanying drawings. For the convenience of description, the same components in the following embodiments are indicated by the same reference numerals.

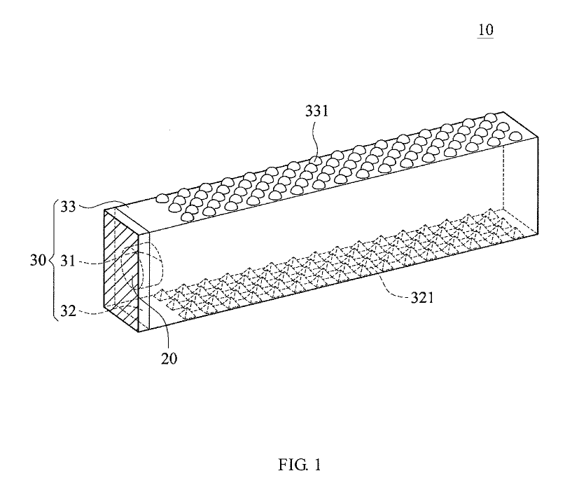

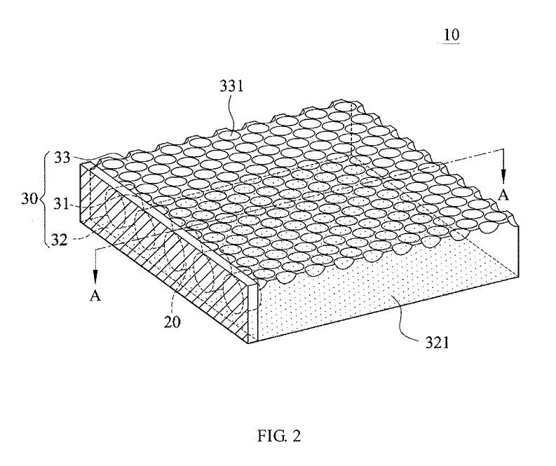

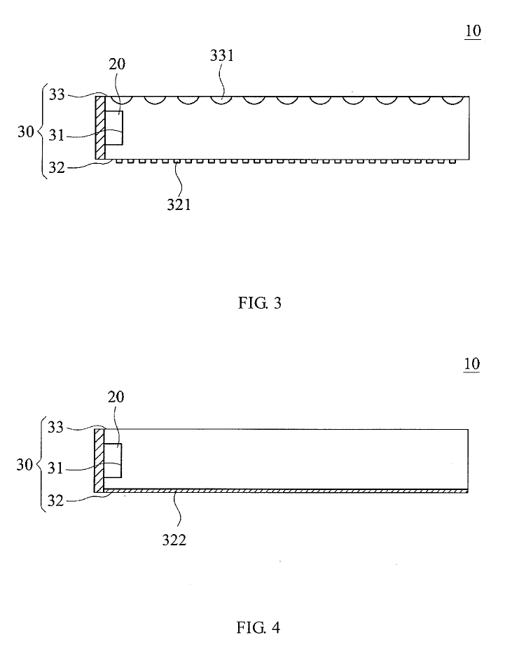

Please refer to FIGS. 1, 2 and 3, wherein FIG. 1 is a perspective view of a flexible backlight module 10 according to the first preferred embodiment of the present invention, FIG. 2 is a perspective view of a flexible backlight module 10 according to the second preferred embodiment of the present invention, and FIG. 3 is a sectional view taken along section line A-A in FIG. 2. In the first and second preferred embodiments, the flexible backlight module 10 comprises a light source module 20 and a flexible light guide panel 30.

The light source module 20 is a cold cathode fluorescent lump light source module 20 or an LED light source module 20. The cold cathode fluorescent lump light source module 20 serves as a line source of light whereas a single LED light source module 20 serves as a point source of light. However, if a plurality of LED light source modules 20 are used at the same time, a line source of light can also be formed.

The flexible light guide panel 30, which is in the shape of a strip or a plate, has a light incident surface 31, a light reflecting surface 32, and a light outgoing surface 33. The flexible light guide panel 30 is made of a light guide material, a silicone, an epoxy resin, or a mixture of a silicone and an epoxy resin.

The light incident surface 31 of the flexible light guide panel 30 is directly connected and thereby optically coupled to the light source module 20. For example, the light incident surface 31 is connected to the light source module 20 via injection molding, whereby a silicone is integrally connected to the light source module 20.

As the light incident surface 31 is integrally connected to the light source module 20, the components of the flexible backlight module 10 are simplified, thus lowering the overall production cost. Meanwhile, since there is no medium between and in close contact with the light incident surface 31 and the light source module 20, the light emitted by the light source module 20 can be completely coupled to the flexible light guide panel 30 through the light incident surface 31. Consequently, leakage and loss of light are prevented, and the light emission efficiency of the flexible backlight module 10 is increased.

After the light of the light source module 20 enters the strip-shaped or plate-shaped flexible light guide panel 30 through The light incident surface 31, the light reflecting surface 32 reflects the incident light toward the light outgoing surface 33, thereby projecting the light outward. The light reflecting surface 32 has a plurality of reflective structures 321, such as a plurality of reflective projections, a plurality of cone-shaped projections, a grid structure with a plurality of square cells, a grid structure with a plurality of irregular cells, grooves, and furrows. The provision of the plural reflective structures 321 helps control the angle of reflection of the incident light so that all the incident light is reflected to the light outgoing surface 33.

Meanwhile, the light outgoing surface 33 of the flexible light guide panel 30 has a plurality of microstructures 331, such as a plurality of microlenses, a plurality of grooves, a plurality of light-collecting prisms, and a plurality of dot-shaped projections. The plural microstructures 331 are intended to regulate the light reflected by the light reflecting surface 32. More specifically, the plural microstructures 331 can regulate the angle of the outgoing light so that the light passing through the light outgoing surface 33 of the flexible light guide panel 30 becomes uniform or concentrated.

When the flexible light guide panel 30 has a strip shape, it is applicable to a small flexible backlight module 10. When the flexible light guide panel 30 is in the form of a slab, it is applicable to a large flexible backlight module 10. Due to its flexibility, the flexible light guide panel 30 can be curved and deformed as needed, so as to comply with objects of irregular shapes. Now that the flexible light guide panel 30 is not limited by the shapes of objects to which it is applied, the flexible light guide panel 30 has wide applicability.

Please refer to FIG. 4 for a sectional view of a flexible backlight module 10 according to the third preferred embodiment of the present invention. In the third preferred embodiment, the light reflecting surface 32 of the flexible light guide panel 30 is formed with a metallic reflector 322 for increasing the amount of light passing through the light outgoing surface 33.

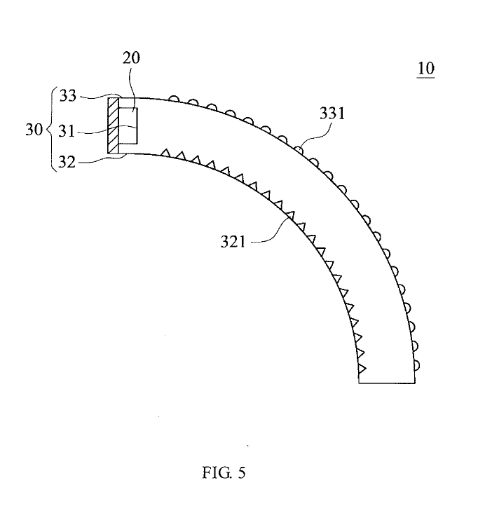

Reference is now made to FIG. 5 for a sectional view of a flexible backlight module 10 according to the fourth preferred embodiment of the present invention. In the fourth preferred embodiment, the flexible property of the flexible light guide panel 30 allows the flexible backlight module 10 to be used in applications where curving and deformation are required. When the flexible light guide panel 30 is curved, both the light reflecting surface 32 and the light outgoing surface 33 are curved.

In order to prevent the optical path of light emitted by the light source module 20 from distortion which may result from the curved shape of the light reflecting surface 32 and the light outgoing surface 33 and lead to a weakening of light intensity in an area distant from the light source module 20, the light reflecting surface 32 and the light outgoing surface 33 of the flexible light guide panel 30 are provided with a plurality of reflective structures 321 and a plurality of microstructures 331 respectively.

With the cooperation of the plural reflective structures 321 and the plural microstructures 331, the light emitted by the light source module 20 can be distributed evenly in the entirety of the flexible backlight module 10 without being affected by the curvature of the flexible light guide panel 30, thus achieving optimal light emission efficiency. Therefore, the flexible backlight module 10 can be curved freely according to practical needs but is still capable of emitting light at optimal efficiency.

The plural reflective structures 321 and the metallic reflector 322 on the light reflecting surface 32 of the flexible light guide panel 30 and the plural microstructures 331 on the light outgoing surface 33 of the flexible light guide panel 30 can be provided in arbitrary combination to suit practical needs and achieve the optimal effects.

The embodiments described above are only the preferred embodiments of, but not limitations to, the present invention. While the present invention is disclosed herein with reference to the preferred embodiments, the embodiments are not intended to restrict the present invention. Based on the technical contents disclosed herein, a person skilled in the art may alter or modify the foregoing embodiments and thereby produce equivalent embodiments without departing from the scope of the present invention. Therefore, all minor alterations and equivalent changes which are based on the technical substance of the present invention and made to the foregoing embodiments should be considered as within the scope of the technical solution of the present invention.

What is claimed is:

1. A flexible backlight module, comprising:
a light source module; and
a flexible light guide panel having a light incident surface, a light reflecting surface, and a light outgoing surface, wherein the light incident surface is directly connected and thereby optically coupled to the light source module.

2. The flexible backlight module of claim 1, wherein the light source module is a cold cathode fluorescent lump light source module or a light-emitting diode (LED) light source module.

3. The flexible backlight module of claim 1, wherein the flexible light guide panel is in form of a slab or a strip.

4. The flexible backlight module of claim 1, wherein the flexible light guide panel is made of a flexible light guide material, a silicone, an epoxy resin, or a mixture of a silicone and an epoxy resin.

5. The flexible backlight module of claim 1, wherein the light reflecting surface has a plurality of reflective structures.

6. The flexible backlight module of claim 1, wherein the light reflecting surface is formed with a plurality of reflective projections or a metallic reflector.

7. The flexible backlight module of claim 1, wherein the light outgoing surface is formed with a plurality of microlenses.

8. The flexible backlight module of claim 1, wherein the light outgoing surface has a plurality of microstructures.

9. The flexible backlight module of claim 1, wherein the light reflecting surface has a plurality of reflective structures, and the light outgoing surface has a plurality of microstructures.
